(19) United States
(12) Patent Application Publication
(10) Pub. No.: US 2011/0030664 A1
(43) Pub. Date: Feb. 10, 2011

(54) METHOD AND DEVICE FOR DETERMINING THE COMPOSITION OF A FUEL MIXTURE

(75) Inventors: Jens Schneider, Leonberg (DE); Stephan Uhl, Markgroeningen (DE); Klaus Winkler, Rutesheim (DE); Lothar Diehl, Gerlingen (DE); Dimitrios Stavrianos, Stuttgart (DE); Juergen Wendt, Stuttgart (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/864,385

(22) PCT Filed: Nov. 14, 2008
(86) PCT No.: PCT/EP2008/065531

§ 371 Date: Oct. 13, 2010

(30) Foreign Application Priority Data
Jan. 25, 2008 (DE) 102008006029.1
Nov. 13, 2008 (DE) 102008043697.6

(51) Int. Cl. F02D 19/08; F02D 41/00

(52) U.S. Cl. 123/703

(57) ABSTRACT

The invention relates to a method and device for determining the composition of a fuel mixture made of one first fuel and at least one second fuel for operating an internal combustion engine, wherein said internal combustion engine has a fuel metering apparatus and at least one exhaust gas probe in an exhaust gas channel. According to the method of the invention, it is provided that the fuel mixture is at least temporarily supplied to the exhaust gas probe at least partially uncombusted, and the composition of the fuel mixture is determined from an output signal of the exhaust gas probe. According to the device of the invention, it is provided that the exhaust gas probe is situated proximal to the motor in the direction of the exhaust gas flow before a first catalytic converter, and the fuel mixture can be supplied at least partially uncombusted to the exhaust gas probe at least temporarily. The method allows the precise and reliable determination of the composition of a fuel mixture in internal combustion engines operated in flex fuel operation existing components.

### STATE OF THE ART

The invention relates to a method and a device for determining the composition of a fuel mixture consisting of a first fuel and at least a second fuel for operating a combustion engine, whereby the combustion engine provides a fuel metering apparatus and at least one exhaust gas probe in an exhaust gas channel.

Combustion engines based on Otto engines are generally operated with fuel consisting of hydrocarbons made of fossil fuels based on refined mineral oil. Alcohol, for example ethanol or methanol, which is more and more produced from renewable recourses (plants), is added to this fuel in different mixture ratios. In the US and in Europe often a mixture of 75-85% ethanol and 15-25% benzene is used under the trade name E85. The combustion engines are construed in such a way that they can be operated with pure benzene as well as mixtures up to E85, this is called flex-fuel-operation. For a cost-efficient operation with a low pollutant emission at a simultaneously high engine power the operating parameters in the flex-fuel-operation have to be adjusted to the corresponding fuel mixture. A stoichiometric air/fuel-ratio is for example present at 14.7 weight proportions air per proportion benzene, but when using ethanol an air ratio of 9 weights proportions has to be adjusted.

Due to the interaction of sensors the momentary fuel composition before the injection moment and the momentary exhaust gas composition, thus the oxygen-partial pressure, is determined and transferred to the control electronic of the combustion engine. Based on this sensor data the combustion of the combustion engine is optimized, in particular by adjusting the advantageous air/fuel ratio.

For determining the composition of the fuel mixture different fuel type sensors, also called fuel composition sensors, are used. Fuel type sensors use the different features of alcohol and benzene for determining the fuel composition. Ethanol is thus for example a protic solvent, which contains carbon hydrate ions and provides a big dielectricity constant that depends on the water content. Benzene is on the other side an aprotic solvent with a low dielectricity constant. Based on that there are fuel type sensors, which determine the fuel composition by the dielectric features of the fuel mixture. Other fuel type sensors use the different electric conductivity or the different optical features of the fuels as for example the different refraction indices.

DE 41 12 574 describes a fuel supply system for a combustion engine, in which the operation status of the combustion engine is detected and the amount of the fuel that has to be supplied is controlled in accordance with the result of this detection. It is thereby provided that the fuel supply system comprises a fuel type detection device for detecting the fuel type and an arithmetic device for calculating a theoretical air-fuel-ratio that corresponds with the fuel type in accordance with the result of the detection of the fuel type detection device and the amount of the fuel that has to be supplied is controlled by using the theoretical air-fuel-ratio that has been supplied by the arithmetic device as target air-fuel-ratio. It can thereby be provided that the fuel type detection mean detects the fuel type by measuring either at least the refraction index, the dielectricity constant or the mol heat of the fuel in liquid status.

But in order to implement the procedure corresponding sensors have to be provided, which are expensive and error-prone.

It is the task of the invention to provide a procedure and a device, which enable a reliable and cost-efficient detection of the composition of a fuel mixture consisting of at least two fuel types.

### DISCLOSURE OF THE INVENTION

The task of the invention that is considering the procedure is thereby solved, in that the exhaust gas probe is at least temporarily supplied with the at least partially uncombusted fuel mixture and in that the composition of the fuel mixture is determined from an output signal of the exhaust gas probe. Uncombusted fuels are oxidized at the outer electrode or the measuring electrode of the exhaust gas probe, whereby the output signal of the exhaust gas probe is influenced. Different fuels distinguish themselves thereby, for example alcohol and benzene, by their oxidization ratios and their oxidization kinetic and therefore their influence of the output signal of the exhaust gas probe. Based on the output signal of the exhaust gas probe the composition of the fuel mixture can therefore be determined. It is thereby advantageous that the determination of the composition of the fuel mixture can take place with the aid of exhaust gas probes that are already in modern combustion engines and therefore no additional components and sensors are required.

For the evaluation of the output signal of the exhaust gas probe it is advantageous if the amount of the uncombusted fuel that is supplied to the exhaust gas probe is familiar. Therefore it can be provided that the exhaust gas probe is supplied with a pre-defined amount of the fuel mixture.

The exhaust gas probe can be supplied with uncombusted fuel without additional components and without an influencing of the operation of the combustion engine thereby, in that the fuel mixture is supplied to the combustion engine with the aid of the fuel metering apparatus during a boost operation. There is no ignition during the boost operation in particular at externally ignited combustion engines, so that the fuel or the fuel mixture can pass the combustion chamber uncombusted.

According to an alternative embodiment variant of the invention it can be provided that the pre-defined amount of the fuel mixture of the combustion engine is supplied with the aid of the fuel metering apparatus so late after an upper dead point that the fuel mixture reaches the exhaust gas probe at least partially uncombusted. The metering of the fuel into the corresponding combustion chamber of the combustion engine takes then place significantly after the ignition of the main injection, the fuel mixture is not combusted anymore or only incompletely.

According to an especially preferred embodiment of the invention it can be provided that the fuel mixture of the combustion engine is supplied with the aid of the fuel metering apparatus at least partially during an output stroke at an opened outlet valve. That way the fuel mixture can pass the combustion chamber uncombusted and get to the exhaust gas probe. It is thereby advantageously that the fuel mixture is not compressed, which causes a bigger difference of the output signal of the exhaust gas probe when impinging for example with benzene or with ethanol.

The amount of fuel that is required for determining the composition of the fuel mixture can be thereby limited in that the uncombusted fuel mixture is supplied to a cylinder or a selected number of cylinders at combustion engines with several cylinders. The remaining cylinders are not supplied with any fuel during the determination of the composition of the fuel mixture. That way also the emission of uncombusted hydrocarbon can be reduced.

A catalytic oxidization of the uncombusted fuel at the outer electrode or the measuring electrode of the exhaust gas probe that is as slow as possible causes an improved reliability and measuring accuracy when determining the composition of the fuel mixture with the aid of the output signal of the exhaust gas probe. Therefore it can be provided that the temperature of the exhaust gas probe is reduced during the determination of the composition of the fuel mixture. A reduced temperature of the exhaust gas probe and therefore of the outer electrode or the measuring electrode causes a reduced oxidization speed of one of the fuel components.

The accuracy of the composition of the fuel mixture with the aid of exhaust gas sensors depends on different influence parameters, amongst others on the used exhaust gas sensor. An accuracy that is better than 30% can already be used as additional indication to the software algorithms, with which the composition of fuel mixtures is determined nowadays according to different procedure. With an accuracy better than 10% an ethanol sensor with a lower quality can be used, with an accuracy better 5% an ethanol sensor of high quality according to the state of the art can be used. Therefore it can be provided that the determination of the composition of the fuel mixture takes place exclusively from the signal of the exhaust gas probe or in a combination with other procedures for determining the composition of the fuel mixture.

According to a particularly preferred embodiment of the invention it can be provided that a wideband lambda probe is used as exhaust gas probe. Wideband lambda probes are today used very commonly in the exhaust gas channel of combustion engines. Wideband lambda probes that are built-in close to the engine before a first catalytic converter are therefore particularly appropriate for determining the composition of fuel mixtures.

A difference of the oxidization kinetic of different fuel components, for example benzene and alcohol, that is as big as possible at the outer electrode or the measuring electrode of the exhaust gas probe with the above mentioned positive influence on the reliability and measuring accuracy of the procedure can be realized at wideband lambda probe thereby, in that the temperature of the exhaust gas probe is adjusted to an area 550° C. to 700° C. or to an area of 400° C. to 550° C. during the determination of the composition of the fuel mixture.

The determination of the composition of the fuel mixture can take place thereby, in that a change of a pump current of the wideband lambda probe versus a reference value for determining the composition of the fuel mixture. The reference value of the pump current can thereby be stored for a familiar fuel mixture or for a pure fuel.

According to an alternative embodiment of the invention it can be provided, that a lambda probe with a jump characteristic is used as exhaust gas probe. Such lambda probes are cost-efficient and also very common. Due to the low costs for such a lambda probe it can also be economically useful to provide it only for the determination of the composition of the fuel mixture without further tasks regarding the determination of the exhaust gas composition close to the engine.

A difference of the oxidization kinetic of different fuel components, for example benzene and alcohol, at the outer electrode or the measuring electrode that is as big as possible can be realized at lambda probes with a jump characteristic thereby, in that the temperature of the exhaust gas probe is adjusted to an area of 500° C. to 650° C. or to an area of 350° C. to 500° C. during the determination of the composition of the fuel mixture.

A simple evaluation of the output signal of the lambda probe with a jump characteristic is thereby enabled, in that a shifting of an output signal of the exhaust gas probe in the rich area is used for determining the composition of the fuel mixture.

According to a further alternative variant of the invention it can be provided that an exhaust gas probe is used, which is sensitive to hydrocarbons. A lambda probe with an additional hydrocarbon sensitivity or a pure hydrocarbon probe can thereby be used. In the case of a lambda probe with an additional hydrocarbon sensitivity jump lambda probes as well as wideband lambda probes can be provided. Such lambda probes with an additional hydrocarbon sensitivity are familiar. Additional electrode systems are provided for determining the hydrocarbon content in the exhaust gas. The function of the exhaust gas controlling is taken over by the lambda probe. The use of exhaust gas probes that are sensitive to hydrocarbons is advantageous because of the increased measuring accuracy of those probes. Combined systems of lambda probes and hydrocarbon sensors have thereby the advantage that the exhaust gas controlling as well as the determination of the composition of the fuel mixture can take place with one component. It is advantageous to use a pure hydrocarbon probe without a lambda functionality because it can be optimally adjusted to the requirements for the accurate determination of the composition of the fuel mixture, for example for adjusting the electrodes or the probe temperature.

The best accuracy for determining the composition of a fuel mixture can thereby be achieved, in that the temperature of the exhaust gas probe that is sensitive to hydrocarbon is adjusted to an area of 400° C. to 650° C. during the determination of the composition of the fuel mixture.

The task of the invention that concerns the device is thereby solved, in that the exhaust gas probe is arranged close to the engine in the direction of the exhaust gas current before a first catalytic converter and in that the exhaust gas probe can be supplied at least temporarily with the fuel mixture that is at least partially uncombusted. Due to the arrangement of the exhaust gas probe before a first catalytic converter uncombusted fuel can be conducted over the combustion engine and the exhaust gas system to the exhaust gas probe without converting the fuel mixture at a catalytic converter. The fuel mixture can thus for example pass the combustion engine uncombusted or partially uncombusted over an injection significantly after the upper dead point or by a supply of the fuel mixture to the combustion engine during a boost operation and be conducted to the exhaust gas probe. The overlapping of the opening of the inlet and outlet valves, the scavenging, is thereby preferably used so that the fuel is not cracked by the compression process and thus the sensitivity difference elapses.

Besides the temperature of the exhaust gas probe the composition or the surface of the outer electrode or the measuring electrode has also a significant influence on the oxidization kinetic of the uncombusted hydrocarbons and thus on the achieved accuracy of the determination of the composition of the fuel mixture. Therefore it can be provided that a catalytically effective outer electrode or measuring electrode of the exhaust gas probe is at least partially passivated. Thus it can be advantageous for lambda probes with a jump characteristic or for exhaust gas probes that are sensitive to hydrocarbons, to increase the selectivity, for example for distinguishing alcohols and alkanes by reducing the activity, for example by using a mixture potential Au/Pt-Electrode.

The procedure and/or device can preferably be used for determining the composition of a benzene/ethanol-fuel mixture and/or a benzene/methanol-fuel mixture and/or a benzene/ethanol7methanol fuel mixture.

### SHORT DESCRIPTION OF THE DRAWINGS

The invention is further explained in the following with the aid of the embodiments that are showed in the figures. It is shown in:

FIG. 1 a combustion engine with a intake duct and an exhaust gas channel in a schematic illustration,

FIG. 2 the time course of injection times during diagnose phases for determining the composition of a fuel mixture,

FIG. 3 the time course of output signals of a wideband lambda probe during diagnose phases for determining the composition of a fuel mixture.

### EMBODIMENTS OF THE INVENTION

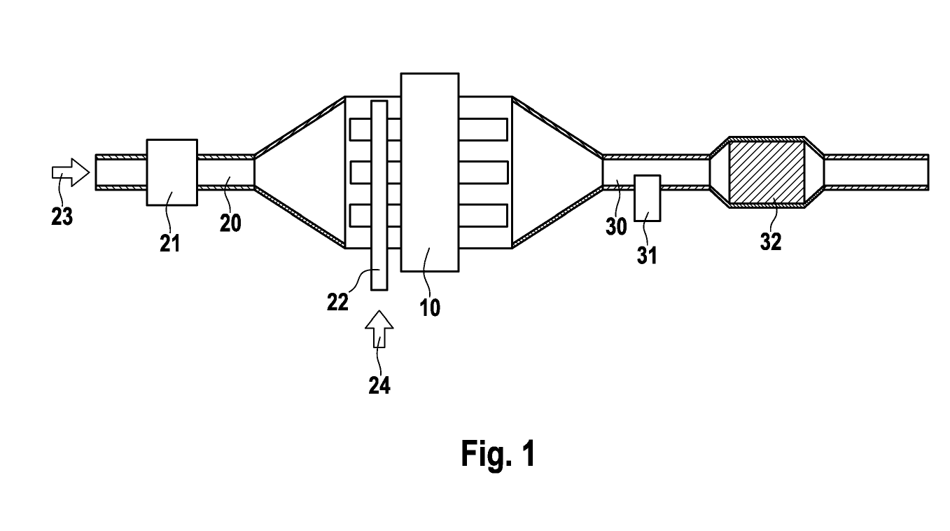

FIG. 1 shows a combustion engine 10 with an intake duct 20 and an exhaust gas channel 30 in a schematic illustration. The intake duct 20 is assigned to an air mass sensor 21, which determines the mass of air 23 that is supplied to the combustion engine. A fuel metering apparatus 22 is provided directly in front of the combustion engine 10. The fuel metering apparatus 22 allows the supply of defined amounts of a fuel mixture 24 to the combustion engine 10.

In the exhaust gas channel 30 of the combustion engine 10 in the direction of the exhaust gas current there is an exhaust gas probe 31. The exhaust gas probe 31 is thereby located directly next to the combustion engine 10 in front of a first catalytic converter 32.

The combustion engine 10 is construed as Otto engine in the shown embodiment, which is operated in a flex-fuel-operation with fuel mixtures 24 consisting of benzene and alcohol. The fuel mixture 24 is thereby directly injected in front of the not displayed injection valves of the combustion engine 10 into the intake duct 10 and supplied to the combustion engine 10 together with the sucked in air 23.

The exhaust gas probe 31 that is arranged close to the engine corresponds in the embodiment with a lambda probe with jump characteristics. It serves the controlling of the exhaust gas values and accordingly regulates the air and fuel supply of the combustion engines 10.

It is provided according to the invention that the exhaust gas probe 31 is supplied with an uncombusted or at least partially uncombusted fuel mixture 24 for determining the composition of the fuel mixture 24. In the illustrated embodiment this takes place thereby, in that a defined amount of the fuel mixture 24 is supplied in diagnose phases during boost operations of the combustion engines 10. The air-fuel mixture is not ignited and gets uncombusted to the exhaust gas probe 31 during the boost operation.

Due to the different oxidization kinetic of benzene and alcohol the output signal of the exhaust gas probe 31 is influenced differently at fuel mixtures 24 of a different composition. At lambda probes with jump characteristics as it is used here this causes in particular differences in the shifting of the rich gas signal. The alcohol causes thus a smaller shifting of the rich gas signal as compared to a similar volume of the benzene that is supplied to the exhaust gas probe 31, which can be used for the determination of the alcohol percentage in the fuel mixture 24. The effect can be intensified thereby, in that the temperature of the exhaust gas probe 31 is reduced during the diagnose phase, whereby the catalytic oxidization of the uncombusted fuel mixture 24 at the outer electrode of the exhaust gas probe 31 takes place slower. Temperature ranges of 350° C. to 500° C. or from 500° C. to 650° C. are appropriate for lambda probes with jump characteristics. It can furthermore be provided that the lambda probe with jump characteristics is operated with a protection layer as limited current probe with linearized characteristics line.

In an alternative embodiment of the invention the exhaust gas probe 31 can be construed as wideband lambda probe. The determination of the composition of the fuel mixture 24 takes here also place during separate diagnose phase, for example during boost operating phases of the combustion engine 10, with the aid of differences in the pump current while using a fuel mixture 24 of different compositions. The change of the pump current can thereby be evaluated versus a familiar reference. For determining the fuel composition of the supplied fuel mixture 24 low temperatures of the exhaust gas probe 31 are also advantageous at wideband lambda probes. Temperature ranges from 550° C. to 700° C. and 400° C. to 550° C. are thereby appropriate.

According to a further alternative embodiment of the invention an exhaust gas probe 31 can be used, which is sensitive to hydrocarbons. Thereby it can be a lambda probe with additional sensors, for example Pt/Au-mixture potential electrodes, for determining hydrocarbons or an exhaust gas probe 31 for determining hydrocarbons without a lambda functionality. In both cases the exhaust gas probe 31 is supplied with an uncombusted or partially combusted fuel mixture 24. The determination of the composition of the fuel mixture 24 takes place with the aid of the hydrocarbon selectivity of the exhaust gas probe 31, preferably in a temperature of 400° C. to 650° C.

It is important for all embodiments that the exhaust gas probe 31 is supplied with an uncombusted or partially combusted fuel mixture 24. The exhaust gas probe 31 is thereby preferably provided close to the combustion engine 10 in front of a first catalytic converter 32 in the exhaust gas channel 30. The exhaust gas probe 31, depending on the used combustion engine 10, can thus be supplied with an uncombusted fuel mixture 24 thereby, in that a defined amount of the fuel mixture 24 is added during the diagnose phase with the aid of a direct injection or in that the defined amount of the fuel mixture 24 is reduced during a boost operating phase of the combustion engine 10 or so late after the upper dead point that it can get to the exhaust gas probe 31 uncombusted or partially combusted.

Thereby the supplied amount of the fuel mixture 24 has to be limited in such a way that no damage of the catalytic converter 32 or subsequently arranged components takes place by the oxidization of the fuel mixture 24 at the subsequent catalytic converter 32 and the thereby released heat energy.

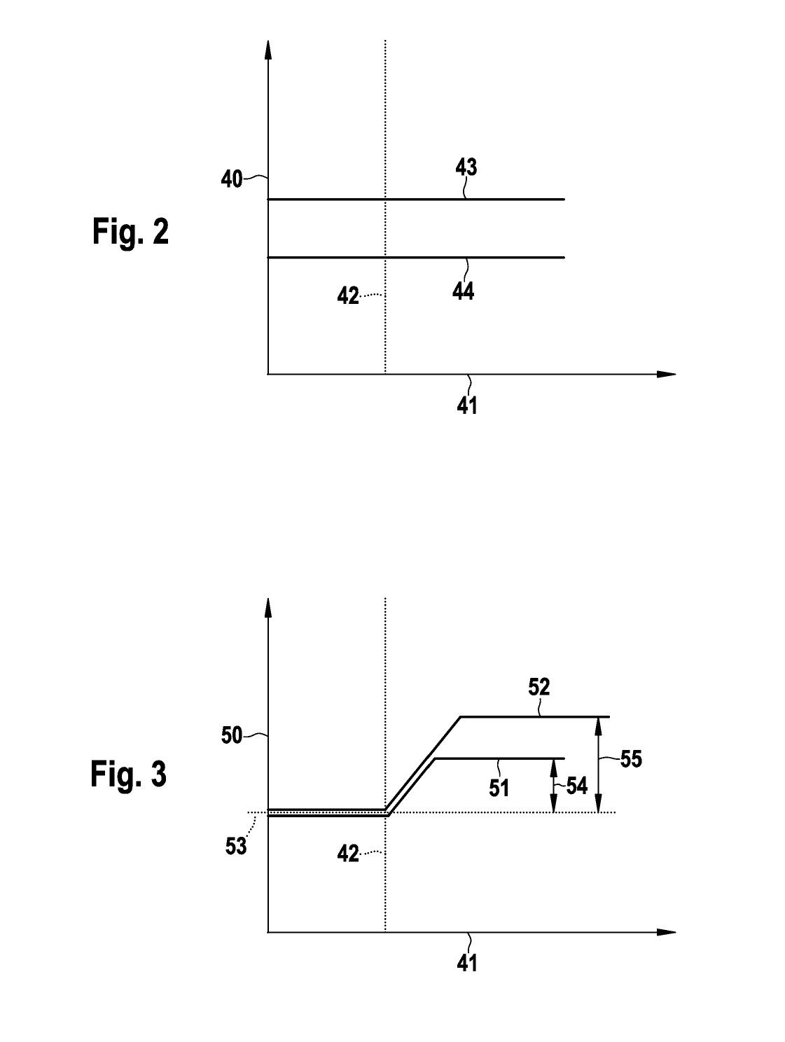

FIG. 2 shows the time course of injection times 43, 44 during diagnose phases for determining the composition of the fuel mixture 24. The injection time ti 40 is thereby put on the time axis 41. A curve injection time ethanol 43 shows the injection time for ethanol and a curve injection time benzene 44 shows the injection time for benzene over a switch point 42.

The injection times ti 40 define the duration of the injection process and thereby the amount of the supplied fuel. Due to the different stoichiometric air/fuel-ratio for ethanol and benzene for a combustion at a lambda of 1 the injection time ethanol 43 is adjusted by the active lambda regulation of the combustion engine 10 higher than the injection time benzene 44. The ratio of the injection time ethanol 43 towards the injection time benzene 44 and thus the ratio of the fuel amounts that have been supplied with every injection process amounts to a lambda of 1 in about 1.33.

The combustion engine 10 is operated from the switching point of time 42 in boost operation at a switched off ignition. For determining the composition of the fuel mixture 24 the injection times 43, 44, that have been adjusted before the switching point of time 42 and thus the injection amounts are maintained from the switching point of time 42, as opposed to the usual operation of the combustion engine 10. The supply of fuel can thereby take place for all cylinders of the combustion engines 10 or be limited to one cylinder or to a selection of cylinders. Because no ignition takes place the fuel can pass the combustion chamber uncombusted in the direction of the exhaust gas channel 30 and exhaust gas probe 31. The exhaust gas probe 31 that is shown in FIG. 1 is thus supplied with a defined amount of uncombusted fuel.

FIG. 3 shows the time course of output signals 51, 52 of a wideband lambda probe during a diagnose phase for determining the composition of the fuel mixture 24. Therefore an output voltage 50 of the lambda probe is put on towards the time axis 41 that is introduced in FIG. 1. The switching point of time 42 marks the point of time of the switching from a regular operation of the combustion engine 10 under load into boost operation at a switched off ignition. The fuel supply is thereby continued according to the injection times 43, 44 that are shown in FIG. 2.

The time course of the output voltage 50 of the wideband lambda probe during the operation of the combustion engine 10 with a fuel mixture 24 E85 consisting of 85% ethanol and 15% benzene is shown in the curve output signal lambda probe ethanol 51, while the curve output signal lambda probe benzene 52 describes the time course of the output voltage 50 of the wideband lambda probe during the operation of the combustion engine 10 with pure benzene. The output signal lambda probe ethanol 51 and the output signal lambda probe benzene 52 are thereby on the same level before the switching point of time 45 and determine there a reference value 53. After the switching point of time 45 a difference ethanol 54 arises between the output signal lambda probe ethanol 51 and the reference value 53 as well as a difference benzene 55 between the output signal lambda probe benzene 52 and the reference value 53.

After the switching point of time 42 uncombusted fuel reaches the wideband lambda probe. The amount of the uncombusted fuel, which is supplied to the wideband lambda probe is thereby determined by the injection time that is adjusted before the switching point of time 42. As soon as uncombusted fuel reaches the wideband lambda probe the output voltage 50 of the wideband lambda probe increases at fuel benzene as well as at a fuel mixture 24 E85. The output signal lambda probe benzene 52 reaches thereby a higher value than the output lambda probe ethanol 51.

The determination of the composition of the fuel mixture 24 takes place with the aid of the differences 54, 55 of the output voltages 50 after the switching point of time 42 versus the reference value 53 that has been created before the switching point of time 42. The output signal lambda probe benzene 52 increases thus according to undertaken measurements at a familiar wideband lambda probe LSU 4.9 by 1.49V versus the previously determined reference value 53. The output signal lambda probe ethanol 51 increased on the other side only by 0.97V versus the reference value 53. For fuel mixtures 24 with mixture ratios, which are between pure benzene and E85, are measured according to changes of the output voltage 50 between 1.49V and 0.97V. With the aid of the difference 54, 55 of the output voltage 50 of the wideband lambda probe while supplying uncombusted fuel can thereby indicate the composition of the fuel mixtures 24. The difference 54, 55 of the output voltage 50 of the wideband lambda probe versus the reference value 53 results from the change of the pump current of the wideband lambda probe when exceeding the switching point of time 42. The change of the pump current is therefore used versus the familiar reference for determining the ethanol percentage in the fuel mixture 24.

1. Method for determining the composition of a fuel mixture made of one first fuel and at least one second fuel for operating an internal combustion engine, wherein said internal combustion engine has a fuel metering apparatus and at least one exhaust gas probe in an exhaust gas channel wherein the exhaust gas probe is supplied at least temporarily with an at least partially uncombusted fuel mixture, and in that the composition of the fuel mixture is determined from an output signal of the exhaust gas probe.

2. The method according to claim 1 wherein the exhaust gas probe is supplied with a pre-defined amount of the fuel mixture.

3. The method according to claim 1 wherein the fuel mixture is supplied to the combustion engine with the aid of a fuel metering apparatus during a boost operation.

4. The method according to claim 1, wherein the pre-defined amount of fuel mixture is supplied to the combustion engine with the aid of the fuel metering apparatus so late after an upper dead point, that the fuel mixture reaches the exhaust gas probe at least partially uncombusted.

5. The method according to claim 1, wherein the fuel mixture is supplied to the combustion engine with the aid of the fuel metering apparatus at least partially during an output stroke while the outlet valve is opened.

6. The method according to claim 3, wherein at combustion engines with several cylinders the uncombusted fuel mixture is supplied to a cylinder or a selected number of cylinders.

7. The method according to claim 1, wherein the temperature of the exhaust gas probe is reduced during the determination of the composition of the fuel mixture.

8. The method according to claim 1, wherein the determination of the composition of the fuel mixture exclusively takes place from the signal of the exhaust gas probe or in that it is carried out in a combination with other methods for determining the composition of the fuel mixture.

9. The method according to claim 1, wherein the exhaust gas probe uses a wideband lambda probe.

10. The method according to claim 9 wherein the temperature of the exhaust gas probe during the determination of the composition of the fuel mixture is adjusted to an area of 550° C. to 700° C. or to an area of 400° C. to 550° C.

11. The method according to claim 9 wherein a change of a pump current of the wideband lambda probe is used versus a reference value for determining the composition of the fuel mixture.

12. The method according to claim 1 wherein a lambda probe with a jump characteristic is used as exhaust gas probe.

13. The method according to claim 12 wherein the temperature of the exhaust gas probe is adjusted to an area of 500° C. to 650° C. or to an area of 350° C. to 500° C. during the determination of the composition of the fuel mixture.

14. The method according to claim 12 wherein a device of an output signal of the exhaust gas probe is used in the rich area for determining the composition of the fuel mixture.

15. The method according to claim 1, wherein an exhaust gas probe is used that is sensitive to hydrocarbons.

16. The method according to claim 15 wherein the temperature of the exhaust gas probe that is sensitive to hydrocarbons is adjusted to an area of 400° C. to 650° C. during the determination of the composition of the fuel mixture.

17. Device for determining the composition of the fuel mixture consisting of a first fuel or at least a second fuel for operating an internal combustion engine, wherein at least one exhaust gas probe is arranged in the exhaust gas channel of the combustion engine wherein the exhaust gas probe is situated proximal to the motor in the direction of the exhaust gas flow before a first catalytic converter, and in that the fuel mixture is supplied at least partially uncombusted to the exhaust gas probe at least temporarily.

18. The device according to claim 17 wherein a catalytically effective outer electrode or a measuring electrode of the exhaust gas probe is at least partially passivated.

19. Application of the method and the device according to claim 1 for determining the composition of the fuel mixture and/or a benzene/methanol fuel mixture and/or a benzene/ethanol/methanol fuel mixture.
